(19) United States
(12) Patent Application Publication
(10) Pub. No.: US 2006/0149656 A1
(43) Pub. Date: Jul. 6, 2006

(54) System and method for conducting auctions of product sets

(75) Inventors: Thomas E. Chefalas, Somers, NY (US); Steven J. Mastrianni, Unionville, CT (US); Clifford A. Pickover, Yorktown Heights, NY (US); Robert W. Wisniewski, Yorktown Heights, NY (US)

Correspondence Address: CONNOLLY BOVE LODGE & HUTZ LLP (IBM YORKTOWN), 1990 M STREET, NW, SUITE 800, WASHINGTON, DC, 20036-3425, US

(73) Assignee: International Business Machines Corporation, Armonk, NY (US)

(21) Appl. No.: 11/027,974

(22) Filed: Jan. 4, 2005

(51) Int. Cl. G06Q 40/00

(52) U.S. Cl. 705/37

(57) ABSTRACT

Systems and method for providing an auction. A computer server has a searchable database of items offered for sale by a plurality of sellers. The database is accessible by a plurality of sellers and a plurality of buyers. A conglomeration agent running on the server identifies related items for sale as a single conglomeration and stores the conglomeration in the database. The buyer may view both individual items for sale and conglomerations of items for sale, and place a bid on a conglomeration of such items or the individual item. If the bid matches the conditions set forth by the sellers, the sale of either a conglomeration or an individual item is completed. The system also generates a performance metric for both buyers and sellers which are also made available to buyer and sellers and may be used to assess the desirability of dealing with certain buyers or sellers.

### TECHNICAL FIELD

This invention relates to the field of online auctions. Specifically, a method and system are disclosed for forming conglomerations of items offered for sale, and offering the conglomerations for sale in an auction.

### BACKGROUND OF THE INVENTION

Electronic commerce has increased the marketability of many items by matching buyers and sellers electronically. Auctions have found increased utility due to the increased popularity of buying and selling products over the internet. Auctions can be conducted with little human intervention, using conventional client server application software and hardware. The advantage of the electronic auction is that the auction need not be held in real time, and bids can be accumulated over a period of time before a sale can be made. Further, buyers need not congregate in a single location to participate in the auction

Online auctions are typically conducted to sell individual items which are purchased when a winning bid is received from a purchaser. If an individual wishes to participate in an online auction to purchase multiple items in a set of related objects, they must normally seek out and find a seller which has either the exact set of items the buyer is searching for, or the buyer must individually purchase items of the desired set from a plurality of potential sellers. Even after an exhaustive search for all of the items of a desired set, the buyer may still risk the inability to purchase the whole set if one of the sellers cannot be accommodated, thereby diminishing the value of the incomplete set of items.

The prior art has addressed some of the difficulties in selling sets of items in an auction. For instance, Published Patent Application US2001/002743181 discloses how multiple, variable bids might be entertained if an item was listed both individually and as part of a set or conglomerate. Published U.S. Patent Application US2003/0208408A1 discloses how various buyers and sellers can deal on items which are in multiple conglomerates, and for different conglomerates containing a given item.

These prior art techniques, however, suffer from an inability to create a product set on-the-fly, based on seller information and buyer information received by the auctioneer. Accordingly, it is desirable to have a mechanism for creating on-the-fly groups of products for sale as a single conglomeration, as well as providing an ability to sell individual items of a set at prices set by the seller and bid by the buyer.

### SUMMARY OF THE INVENTION

A system and method for conducting auctions is provided by the invention. A plurality of sellers forward to an auctioneer a description of items for sale which is stored by the auctioneer in a database. Based on various criteria, conglomerations of items being offered for sale are created by a conglomeration agent and stored as a single conglomeration in a database. The auctioneer can offer the individual items or a conglomeration of such items for sale to prospective buyers. The prices for items for sale may be different, depending on whether the item is sold as an individual item or whether it is a part of a conglomeration.

Conglomerations are formed by a conglomeration agent of the auctioneer. In accordance with a preferred embodiment of the invention, a computer server stores the various items for sale in a database. A conglomeration agent is executed on the computer server which forms conglomerations based on past sales, past requests for sales of conglomerated items, and on other criteria determined through artificial intelligence. Conglomerations may be formed even if the individual items of a set are not presently available, and, once they are available, the conglomeration is then offered for sale.

In accordance with a preferred embodiment of the invention, the auction is conducted on a computer server which is accessible by the computer terminals of potential buyers and sellers. The computer server has a searchable database of items offered for sale by the sellers. Conglomerations are formed by the conglomeration agent of the sale items and are also stored in the database, and offered to sale to the buyers.

A computer product is provided having instructions for carrying out an auction. A computer readable media includes instructions to create a computer server and interface accessible by the computer terminal of a plurality of buyers and sellers. The server maintains a searchable database of items offered for sale by the plurality of sellers accessible to the buyers. The computer product includes instructions for creating a conglomeration agent to identify related items for sale in the database as a potential conglomeration or set of items for sale. Bids are received by the server to purchase the conglomerations or individual items of the conglomeration. When a bid is received matching the offer sale price for the conglomeration, or individual item, the sale is completed.

In accordance with the preferred embodiment of the invention, sellers have the opportunity to specify a different selling price depending on whether the item is sold as part of a conglomeration or individually. Further, the system creates a performance metric for each seller based upon previous sales made by the seller. In this way, a performance metric is available to potential buyers to allow them to assess not only the price being offered on an individual or conglomerated item for sale, but the relative trustworthiness and reliability of each seller.

Similarly, a buyer reliability metric is provided when sellers report their previous satisfaction or dissatisfaction with buyers of previous sales. The buyer metric is then made available to sellers deciding on whether to conclude a transaction with a potential buyer.

### BRIEF DESCRIPTION OF THE DRAWINGS

FIG. 1 is a system block diagram illustrating how a plurality of buyers and sellers can participate in an auction where items are sold individually or in a conglomeration;

FIG. 2 is a system flow chart illustrating the process executed by server 12 of the auctioneer; and

FIG. 3 illustrates the various screens which are presented by the process of FIG. 2 to buyers and sellers participating in an auction.

### DESCRIPTION OF THE PREFERRED EMBODIMENT

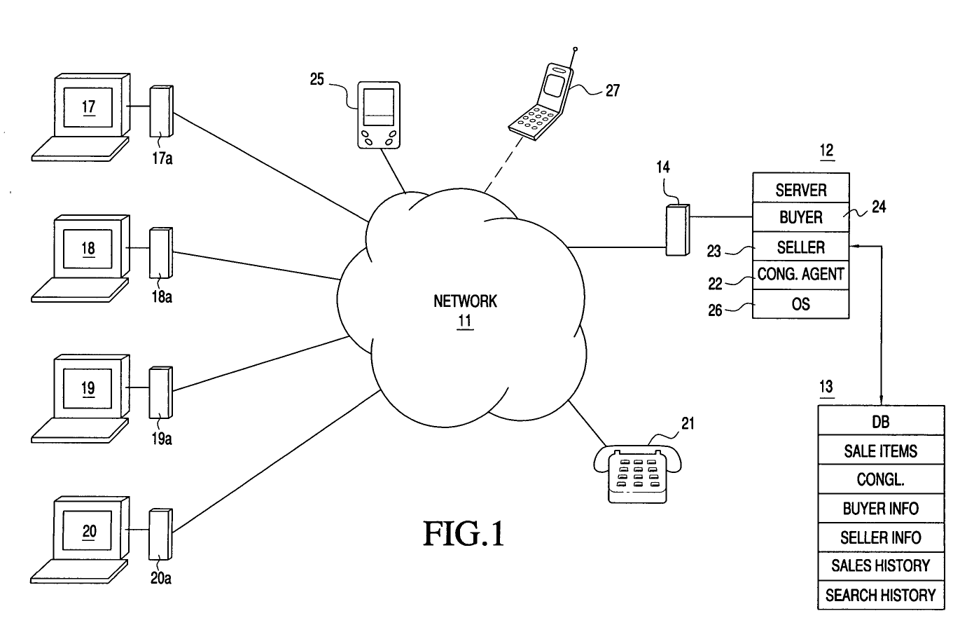

FIG. 1 illustrates a preferred embodiment of the invention that permits a plurality of buyers and sellers to participate in an auction in which items are sold either individually or in a conglomeration. The preferred embodiment of FIG. 1 contemplates that each of the buyers and sellers are connected electronically via a network 11 to an auctioneer server executing a program that conducts an auction. While FIG. 1 depicts a preferred embodiment where buyers 17, 18 and sellers 19, 20 communicate via respective computers to an auction server 12, there are other means by which the invention may be carried out. For instance, it is possible using the claimed method to communicate via telephone 21, cell phone 27, personal digital assistants 25, or other electronic means to an auction server. Additionally, the auction server may interact with people speaking verbal commands over the telephone or operate in response to touch-tones produced by a telephone. While the invention will be described in terms of an e-commerce setting, wherein buyers and sellers participate via computer terminals, this is not to be considered the only means by which such auctions may be conducted. Additionally, while a single server 12 is shown, there may be distributed processing so that the auction is conducted by a plurality of network servers. However, for purposes of describing the preferred embodiment, a single server application 12 will be described.

Buyer computer terminals 17 and 18 are shown connected to an electronic network 11 via interface circuits 17A and 18A. Seller computer terminals 19 and 20 communicate by respective interface circuit cards 19A and 20A with server 12. While separate terminals are shown for buyers and sellers, it will be clear from the description of the system that buyers can also be sellers and sellers can be buyers using their respective computer terminals 17-20.

The auctioneer maintains an auction server 12 which includes several computer applications 24-25 and an operating system 26. Server 12 communicates over network 11 through interface 14. The first application 24 provides for a session with a buyer, such that buyers can indicate their preferences and submit information to the server allowing a bid to be made for an item offered in auction. A second application 23 provides sellers access to the auction site 12 and permits seller information including items for sale, seller identity, an indication whether items may be sold in a conglomeration, and the respective prices of goods to be sold to be stored in database 13. Similarly, buyers supply information such as name, address, financial information necessary to successfully bid on an item or conglomeration offered for sale by application 24.

Additionally, sales history and search history information is maintained by the database. As will be evident from a description of the operation of the server 12, this information is maintained in the database to assist the conglomeration agent 22 running on server 12 to form commercially desirable conglomerations of items for sale.

The present invention relies upon a conglomeration agent running on the server 12 to identify items placed on sale by individual sellers which may have sales appeal when sold as a conglomeration of items. Sellers, when posting items for sale on the server 12, provide an indication of whether or not such items may be included in a conglomeration. Sellers also provide a conglomeration price as well as an individual item price acceptable to the seller. The seller may also place other conditions of sale or conditions when the items are included in a conglomeration. This may include a minimum value of reliability, trust, or other performance metric related to a prospective buyer. Accordingly, the seller is able to configure his own offer based on different criteria.

The conglomeration agent may form a conglomeration of items which have been previously posted for sale, or which have been previously sold via the auction site. If previous conglomerations were sought by buyers, this sales history is stored in the database, and may be used by the conglomeration agent to create future conglomerations. Previous inquiries regarding conglomerations, which were not subject of a sale, constitute part of the stored history data and may be used by the conglomeration agent to form a conglomeration of items for sale. Conglomerations may be formed even if the items are not presently available for sale. By forming potential conglomerations in advance of the availability of an item, a seller may be encouraged to place an item for sale which can be sold as part of a conglomeration with a given sales price premium.

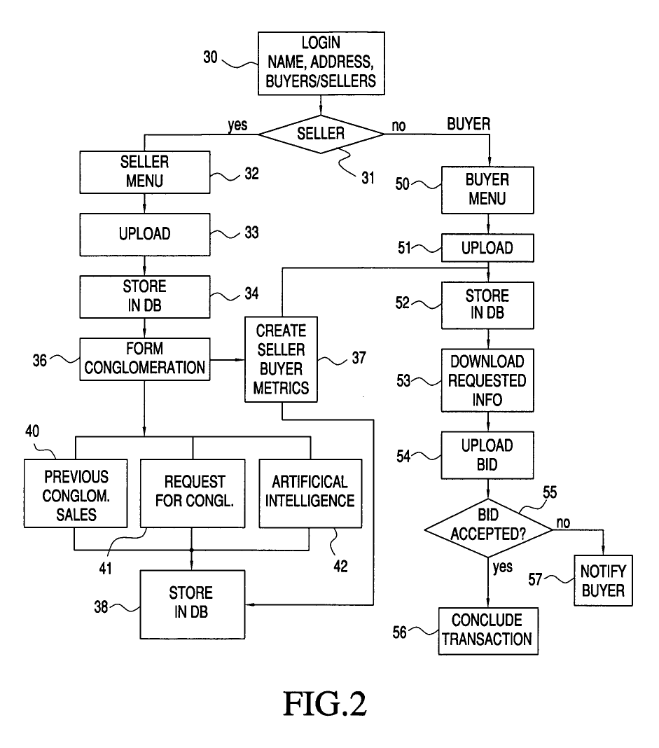

The specifics of the process carried out by the computer server 12 for buying and selling items via auction either as a single item or as part of a conglomeration are shown more particularly in FIG. 2.

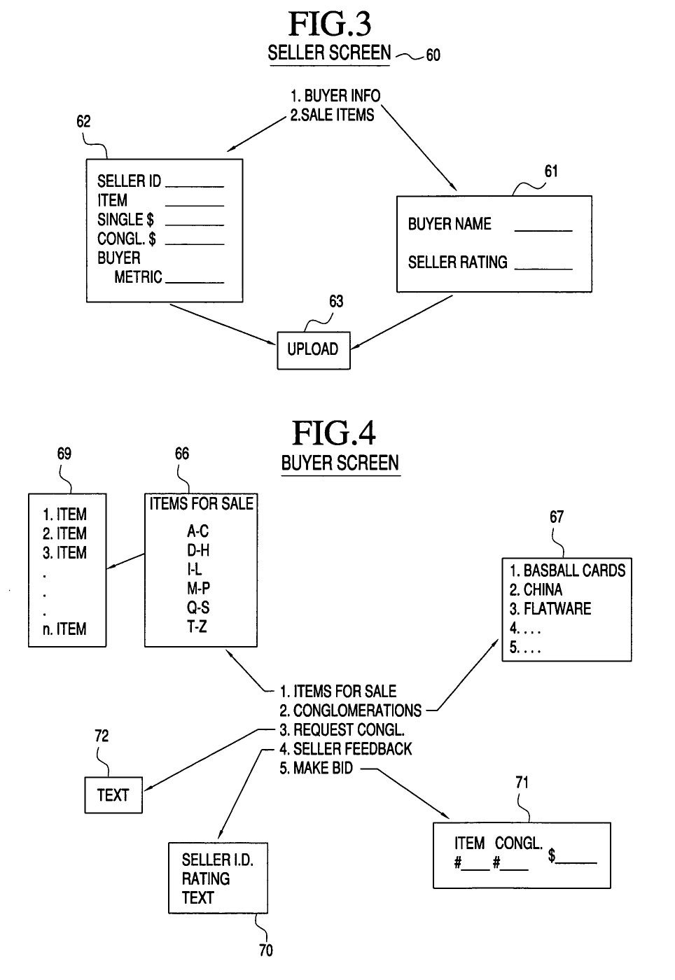

When a buyer or seller logs on to the server 12 in step 30, he receives a menu option of whether to be a buyer or seller. Information is solicited about the buyer/seller including name, address, as well as financial information in the case of a buyer. When the participant indicates he is a seller, as determined in decision block 31, he is presented with a sellers menu in step 32. The sellers menu in step 32 is shown more particularly in FIG. 3. Referring briefly to FIG. 3, it is seen that the seller is given two options, to enter information in screen 61 regarding a party to a previous transaction or enter his own seller information in the seller's information screen 62. Buyer information reported by the seller becomes a part of the previous sale history stored in the database 13. As will be seen with respect to the determination of a reliability metric to be assigned to buyers, the information received in screen 61 will be used by the system to rate the buyer based on the sellers experience with buyers in previous transactions. An option may be provided to permit a buyer or a seller to opt out of having a metric created, and conduct all sales without such a metric. Also, provisions can be made to prevent a seller's or buyer's identity from being disclosed.

Screen 62 permits the seller to enter a previously obtained seller I.D., either obtained before he logged from a previous transaction, or at log in time, as well as information concerning an item for sale. Field 62B is provided to describe the item offered for sale, field 62C the price for the item if sold separately, field 62D the price for the item if sold as a part of a conglomeration, and field 62E is provided to indicate if the seller approves or disapproves of a sale of the item as part of a conglomeration. The seller information in field 62A-62D is uploaded to the server 14 by selecting icon 63 “uploading” includes any method which transfers the screen information to the server. Additionally, the seller may insist that the buyer have an acceptable buyer metric by placing a numerical equivalent in field 62E.

Referring again to FIG. 2, the information uploaded in step 33 is stored in the database 13 in step 34. The database stores the item, sale price, and sale history information regarding the opinion of the seller as to a buyer's performance in a previous transaction. If a conglomeration had been previously formed including such items, the item would be stored as part of the conglomeration in server 13.

Step 35 is the beginning of the execution of the conglomeration agent in the server 12. The conglomeration agent determines whether or not the item received for sale has been the subject of a previous conglomeration sale in step 40. If so, this is a strong factor to be considered in forming a new conglomeration.

If the item has not been a subject of a previous conglomeration, but is the subject of a request by a buyer to purchase a conglomeration, step 41 determines that a conglomeration should be formed including the item. Artificial intelligence 42 determines from the items description related items which may form a conglomeration. For instance, in the case of baseball cards, if the item for sale is a single baseball card, it is possible to have sufficient artificial intelligence to define whether or not the card should be included in a conglomeration with other cards. Similar assessments can be made for specific pieces of china, flatware, etc. to form other conglomerations.

If the conglomeration agent determines that the item belongs as part of a conglomeration, and that the seller has indicated his willingness to sell the item as a conglomerated item, it is stored in database 13 in step 38, along with a price indicating the seller's preferred conglomeration price as well as the seller's individual item price for the item. Alternatively, the conglomeration can be configured to calculate a sale price for the item based on past sales. It may also establish a date of expiration following which the conglomeration is removed from the system.

The conglomeration agent determines in step 37 a sellers and buyers performance metric to be stored in the database 13 along with the item and conglomeration. The sellers metric is, as will be evident from FIG. 4, the result of obtaining an estimation of the seller's performance in a previous transaction from a buyer. Thus, if the buyer was relatively unsatisfied with a previous transaction from the same seller, that information would be used by the conglomeration agent to rate the seller. The rating is stored as a performance metric along with the individual item for sale and any conglomeration containing the item for sale in database 13.

Buyers can log in and view items for sale and conglomerations of items for sale stored in database 13. As shown in FIG. 2, when a buyer logs on, the buyer is presented with a menu in step 50 shown more particularly in FIG. 4. Referring to FIG. 4, the buyer screen includes 5 items which generate in turn 5 different sub-menus. The first item in the buyer screen is a listing of items for sale. If the buyer selects item 1, ITEMS FOR SALE, a second menu 66 is generated showing alphabetically items for sale within database 13 and a seller performance metric. Buyers can base their bid decisions on the sale price as well as the sellers performance metric. When one of the groups of items is highlighted, the listing of items for sale within this group is shown in the menu 69. A buyer can highlight any item for sale, and by subsequently highlighting the MAKE A BID menu instruction, enter a bid for the highlighted item in a third window 71.

Similarly, conglomerations which are stored within the database 13 may be viewed. When the CONGLOMERATIONS item 2 is highlighted, the sub-menu 67 is produced showing each of the conglomerations, which, in the example shown, are baseball cards, china, flatware, etc. Additionally, a seller's metric may be associated (at the seller's option) with each conglomeration representing the performance of either an individual seller owning items within the conglomeration, or an average of the performance metrics for the sellers having goods contained within a conglomeration.

The buyer can additionally request a conglomeration by highlighting the REQUEST CONGLOMERATION selection, and entering text in a window 72 describing a conglomeration. The entry may be a generic such as baseball cards, china, flatware, or the individual items of a desired conglomeration can be entered in a window 72.

Buyer's can also provide feedback in window 70 about previous sales to buyers to rate a seller in accordance with his performance in the previous sale. Thus, delivery or other performance issues which impact on the desirability of doing business with the seller can be entered to develop a seller's metric for the particular buyer. As in the case of a seller, a buyer may request that a buyer metric not be determined.

The foregoing selections and information from the buyer are uploaded by selecting UPLOAD 73 and are shown as received in step 51 of FIG. 2. The uploaded buyer information is stored in database 13.

The buyer may request information about ITEMS FOR SALE or CONGLOMERATIONS FOR SALE shown in FIG. 4 is downloaded to the buyer for display in step 53. As described earlier, this screen permits buyers to select items for sale, to view conglomerations, to request a conglomeration, provide feedback on previous transactions with other sellers, and to make a bid. When the buyer has prepared a bid by filling out the template of screen 71, that information is uploaded by selections 73 and received by the server 12. Server 12 compares the bid information with the seller's sales information. In the event there is an agreement, the transaction is concluded in step 56. This would include notifying both buyer and seller that the transaction has occurred, and having buyer and seller arrange for transfer of possession of the goods as well as payment of the goods.

In the event the bid is not accepted, the buyer is notified in step 57 and the buyer may begin a second bid process.

Acceptance of the bid requires that the sellers of either individual items, or items of a conglomeration, receive their requested compensation. Further, the sellers may insist on an acceptable buyer performance metric so that buyers who in the past have either failed to perform or have credit issues may have their bids denied. A successful bid may therefore depend on a buyer metric acceptable to a seller. Buyer's and seller's can also remain anonymous until the sale has been accepted.

While the invention has been particularly shown and described with reference to preferred embodiments thereof, it will be understood by those skilled in the art that various changes in form and details may be made therein without departing from the spirit and scope of the invention.

1. A method for conducting an auction comprising:
receiving from a plurality of sellers descriptions of items for sale;
forming a database of said descriptions of items for sale;
forming conglomerations of said items for sale and storing conglomerations in said data base; and
offering said items for sale and said conglomeration of items for sale to prospective buyers.

2. The method according to claim 1 wherein said conglomerations are formed based on requests received from potential buyers.

3. The method according to claim 1 further comprising:
forming a metric of each seller based on past sales;
storing said metric in said data base; and
providing said metric to said buyer whereby said buyer can assess the value of a conglomeration.

4. The method according to claim 1 further comprising:
forming a metric of each buyer based on prior sales to said buyers;
storing said metric in said data base; and
providing said metric to said seller whereby said seller can assess the value of a conglomeration.

5. The method according to claim 1 further comprising offering said items for sale at an individual, non-conglomeration price to said purchasers and at a conglomerated price to said purchasers.

6. The method according to claim 1 wherein said sellers are provided an opportunity to sell their items for sale on a non-conglomerated basis.

7. The method according to claim 1 wherein said conglomerations are formed from data extracted from previous searches made by said buyers.

8. The method according to claim 1 wherein said conglomerations are formed based on a previous conglomeration which has been sold.

9. The method according to claim 1 wherein said conglomerations are formed based on previous purchases of related items by the same purchaser.

10. The method according to claim 1 wherein each of said sellers is awarded a price of said goods depending on whether they are sold as a conglomeration or as an individual item.

11. The method according to claim 1 wherein said conglomerations are formed with an expiration time.

12. The method of claim 1 wherein said conglomeration agent establishes a sale price.

13. A system for providing an auction comprising:
a server having a searchable data base of items offered for sale by a plurality of sellers accessible by a plurality of buyers;
a conglomeration agent for identifying related items for sale as a conglomeration, and identifying said conglomeration in said data base; and
a plurality of buyer terminals operatively connected to said server said buyer terminals including a computer program for accessing said data base and viewing said conglomeration and said items for sale.

14. The system according to claim 13 wherein said conglomeration agent determines the contents of a conglomeration from past inquiries made by said buyer.

15. The system according to claim 13 wherein said conglomeration agent identifies for each of said sellers a reliability metric identifying the past level of service by said sellers.

16. The system according to claim 13 wherein said conglomeration agent monitors selling activities to determine which of said items for sale constitute a conglomeration.

17. The system according to claim 13 wherein said conglomeration agents determine a conglomeration from search requests issued by said buyer terminals.

18. The system according to claim 13 wherein said conglomeration agents receive from said sellers an indication of whether said items for sale may be sold in a conglomeration.

19. A system for providing an auction comprising:
a computer server having a searchable data base of items offered for sale by a plurality of sellers accessible by a plurality of buyers;
conglomeration agent running on said server for identifying related items for sale as a conglomeration, and identifying said conglomeration in said database; and
a plurality of seller terminals operatively connected to said server for registering items for sale and conditions for an offer of sale for said items;
a plurality of buyer terminals operatively connected to said server, said buyer terminals including a computer program for accessing said data base and viewing said conglomeration and said items for sale and entering a bid for said conglomeration or individual items for sale; and
transaction means for concluding a sale of a conglomeration bid and a sellers offer for sale agree.

20. The system according to claim 19 wherein said server provides to said seller terminals a selection of whether to include an item in a conglomeration or not, and receives from said seller terminal conditions of sale depending on whether said seller agrees to sell said item in a conglomeration.

21. The system according to claim 19 further comprising means for collecting data on past sales of items.

22. The system according to claim 21 wherein said conglomeration agent receives information from said means for collecting and forms collections based on said information.

23. The system according to claim 22 wherein said conglomeration agent determines from past sales as well as from items in said data base which are to be sold as a conglomeration.

24. A computer product for creating an auction comprising a computer readable media containing instructions for creating:
a computer server accessible by a plurality of sellers, said server having a searchable data base of items offered for sale by said plurality of sellers and which is accessible to a plurality of buyers;
a conglomeration agent for identifying related items for sale in said data base as a conglomeration;
means for receiving a bid for said conglomeration or individual items for sale from said plurality of buyers; and
transaction means for concluding a sale of a conglomeration in which a buyer's bid and a sellers offer for sale agree.

25. The computer product for creating an auction according to claim 24 further comprising instructions for creating a conglomeration based on a request received from a buyer.

26. The computer product for creating an auction according to claim 24 further comprising instructions for calculating a metric for each buyer and seller based on past sales to said buyer and seller.
